(19) United States
(12) Patent Application Publication
(10) Pub. No.: US 2003/0006327 A1
(43) Pub. Date: Jan. 9, 2003

(54) Apparatus for condensing and treating garbage

(76) Inventor: Ihn Po Ryu, Fort Lee, NJ (US)

Correspondence Address: Joseph W. Schmidt, DILWORTH & BARRESE, LLP, 333 Earle Ovington Blvd., Uniondale, NY, 11553, US

(21) Appl. No.: 09/899,889

(22) Filed: Jul. 6, 2001

(51) Int. Cl. B02C 18/16

(52) U.S. Cl. 241/159; 241/236

(57) ABSTRACT

An apparatus for treating and condensing wet garbage and/or food garbage includes a housing having a garbage inlet and a garbage outlet associated therewith and defining a treatment path along which wet garbage passes for treatment, a pair of primary comminuting gears disposed along the treatment path downstream of the garbage inlet for providing a primary comminuting action on the wet garbage, and a pair of secondary comminuting gears disposed along the treatment path downstream of the primary comminuting gear for providing a secondary comminuting action on the wet garbage. The primary or secondary comminuting gears are preferably helical gears with intermeshing teeth, and may include transverse grooves extending at least partially through their teeth to facilitate passage of the garbage material between the gears. The apparatus may further include a compacting member and a filter disposed downstream of the secondary comminuting gears, which are configured to provide a compacting action on the wet garbage while also removing a substantial volume of the liquid therefrom.

### FIELD OF THE INVENTION

The present invention generally relates to an apparatus for treating garbage materials. In particular, the invention relates to an apparatus and associated processes for comminuting and reducing the volume of food waste and/or wet garbage materials, and further relates to treating and handling the resultant waste product thereby generated.

### BACKGROUND OF THE RELATED ART

Accumulation of garbage materials, particularly, food waste, wet garbage, organic and/or raw garbage at homes, restaurants, schools, military bases, etc., has created important social issues including concerns of environmental contamination or pollution. Such garbage or waste generally contains a high volume of liquid component and, consequently, spoils or decays at a relative rapid rate while generating offensive odors to the surrounding environment. The garbage also becomes sources of infectious diseases and serves as food sources for rats and other harmful animals or vermin.

Handling of voluminous garbage is also financially or economically burdensome due to the substantial cost of treating and handling the garbage realized both at individual and governmental levels. Moreover, the great amount of garbage generated in the modern era of mass consumption is outpacing the number of available landfills to bury such waste. Considerations regarding landfill space are especially prevalent in urban areas where population growth has resulted in suburban expansion of the landfills to locations well outside the respective urban area, thereby necessitating the relocation of existing landfills and the creation of new costly landfills at locations geographically remote from the areas in which they serve.

To address these concerns, emphasis has been placed on the development of garbage treatment apparatus to reduce the volume of garbage generated at a site. Such prior treatment apparatus typically include knife rollers or shredders, etc. to slice the garbage material into smaller pieces and conveyors to direct the garbage material to a discharge outlet. The garbage material may be subjected to heat to remove the liquid from the material, thereby reducing the volume and weight of the material. These known devices, however, are subject to certain disadvantages which detract from their usefulness. Particularly, the devices are incapable of continually handling the garbage without failure of their mechanisms. Additionally, in the case of devices directed to treat and condense food wastes, the introduction of non-food waste, including bones, plastics, papers, etc., further increases the possibility of mechanical failure. Moreover, the prior devices are deficient in sufficiently condensing the garbage material for subsequent handling processes.

Accordingly, in view of the aforementioned significant social, environmental and economic issues associated with the handling of garbage material, the development of a garbage treatment and reduction apparatus which would greatly reduce the volume of garbage and substantially remove the water or liquid content therefrom would be highly advantageous.

### SUMMARY OF THE INVENTION

Accordingly, the present invention is directed to an apparatus for comminuting and reducing the volume of garbage materials, particularly, wet garbage. The term “wet garbage” referred to hereinafter is garbage material having a predetermined level of moisture content and includes food waste products, organic and/or raw garbage materials, etc.

Generally, the present invention discloses an apparatus for condensing garbage including a comminution mechanism, a compaction and dewatering mechanism, a garbage input facilitating mechanism, and a condensed garbage and waste liquid discharge system. The apparatus is highly efficient and effective in comminuting and condensing food garbage, wet garbage and the like. The apparatus can provide a relatively high ratio of compression and dehydration of the garbage materials. Further, with the aid of the garbage input facilitating mechanism, the garbage materials may be easily introduced through the comminution mechanism, and thus the invention is also effective in comminuting materials which may accompany the disposal of food, such as paper dishes, napkins, and plastic materials. Even rigid materials, for example, bones, woods, steel scraps, etc., can be processed.

In one preferred embodiment, the apparatus for treating and condensing wet garbage includes a housing having a garbage inlet and a garbage outlet associated therewith and defining a treatment path along which wet garbage passes for treatment, a pair of primary comminuting gears disposed along the treatment path downstream of the garbage inlet for providing a primary comminuting action on the wet garbage and a pair of secondary comminuting gears disposed along the treatment path downstream of the primary comminuting gears for providing a secondary comminuting action on the wet garbage. The primary comminuting gears may be configured to cooperate to provide a relative coarse comminuting action on the wet garbage. The secondary comminuting gears may be configured to cooperate to provide a relative fine comminuting action on the wet garbage. The primary or secondary comminuting gears are preferably helical gears with intermeshing teeth. The gears may include grooves extending at least partially through their teeth. The grooves are dimensioned to facilitate passage of the garbage material between the gears and may extend in a general transverse relation to an axis of rotation of the gears.

The apparatus may further include a compacting member disposed downstream of the secondary comminuting gears. The compacting member in the form of, e.g., a rotatable compacting screw, is dimensioned and configured to provide a compacting action on the wet garbage while also removing a substantial volume of the liquid therefrom. A filter having a plurality of liquid drainage openings at least partially accommodates the compacting screw and cooperating with the compacting screw to reduce the volume and remove liquids of the garbage material upon rotation of the compacting screw. The compacting screw may taper outwardly from an upstream location to a downstream location thereof.

The apparatus may further include a discharge member disposed downstream of the compacting member to convey the garbage material toward the garbage outlet. The discharge member may be a rotatable auger. The apparatus may also include an input facilitating member mounted with respect to the housing adjacent the garbage inlet. The input facilitating member is configured to direct the wet garbage toward the primary comminuting gears. The input facilitating member may include a pusher having a blade associated therewith and adapted for reciprocal movement to sever the wet garbage.

The apparatus may further include a liquid delivery mechanism for directing a liquid stream adjacent at least one of the primary and secondary gears to remove residual garbage material therefrom. A garbage treatment applicator for applying a chemical substance, e.g., deodorants, aroma generating chemicals, preservatives, rodenticides, appetite suppressors, and biocides and the like) to the garbage material prior to passing through the garbage outlet may also be provided.

In another preferred embodiment, the apparatus for condensing substantially wet, raw and/or food garbage material includes a housing having a garbage inlet and a garbage outlet associated therewith and defining a treatment path along which the garbage material passes for treatment, at least one pair of intermeshing comminuting gears disposed along the treatment path downstream of the garbage inlet for providing grinding of the garbage material, an input facilitator mounted adjacent the comminuting gears to direct the garbage material toward the comminuting gears, a compacting screw and filter downstream of the comminuting gears for compacting and removing liquid from the garbage material, and a discharge member disposed downstream of the compacting screw and filter to convey the garbage material toward the garbage outlet.

### BRIEF DESCRIPTION OF THE DRAWINGS

Preferred embodiments of the disclosure are described herein with reference to the drawings, wherein:

FIG. 1 is a schematic view of the apparatus for treating garbage material in accordance with the principles of the present invention;

FIG. 2 is a schematic view illustrating the two-stage comminution mechanism, the compaction and dewatering mechanism, and the liquid discharge mechanism of the apparatus of FIG. 1;

FIG. 3 is a side elevational view of the apparatus of FIG. 1;

FIG. 4 is a schematic view of an alternative embodiment of the apparatus of FIG. 1 incorporating a one-stage comminution mechanism;

FIG. 5 is a perspective view of a set of coupled helical gears of the comminution mechanism of the apparatus;

FIG. 6 is a cross-sectional view of primary gears of the comminution mechanism taken along the line 6-6 of FIG. 5;

FIG. 7 is a cross-sectional view of the secondary gears of the comminution mechanism;

FIG. 8 is a perspective view of an alternate embodiment of the coupled helical gears of the comminution mechanism;

FIG. 9 is a side view illustrating the cylindrical dewatering filter and receiving hopper of the compaction and dewatering mechanism;

FIG. 9A is an enlarged view illustrating the drainage holes of the cylindrical filter;

FIGS. 10 and 10A are side views illustrating alternate respective embodiments of the compaction screw of the compaction and dewatering mechanism;

FIG. 11 is a perspective view of a conical cap to be assembled to the distal end of the cylindrical dewatering filter;

FIG. 12 is a side view illustrating the discharge tube of the garbage discharge mechanism of the apparatus;

FIG. 13 is a side view illustrating a discharge screw of the discharge mechanism; and

FIG. 14 is a perspective view illustrating the preferred drive mechanism of the apparatus.

### DETAILED DESCRIPTION OF THE PREFERRED EMBODIMENTS

The preferred embodiments of the apparatus for condensing and treating garbage materials, particularly, wet garbage materials, are described herein. As discussed hereinabove, the term “wet garbage” will refer to any materials having a substantial moisture or liquid content including, e.g., food garbage or waste, organic or raw garbage, meat, poultry, fish, etc. However, as will be appreciated, the present apparatus is advantageously capable of handling relative “hard” garbage materials such as bones, plastics, knives, forks, paper, etc. which may accompany the disposal of the wet garbage.

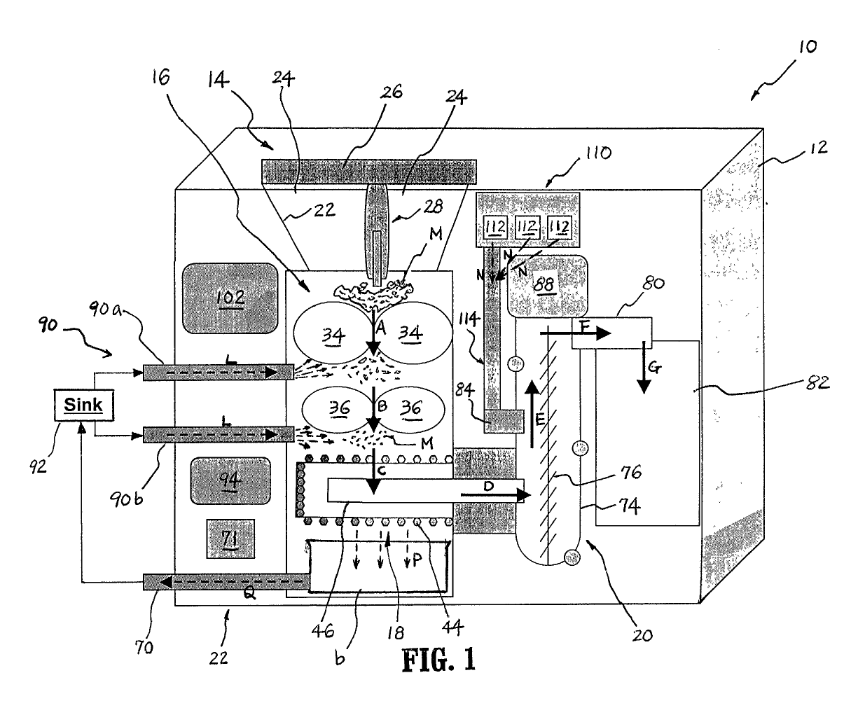

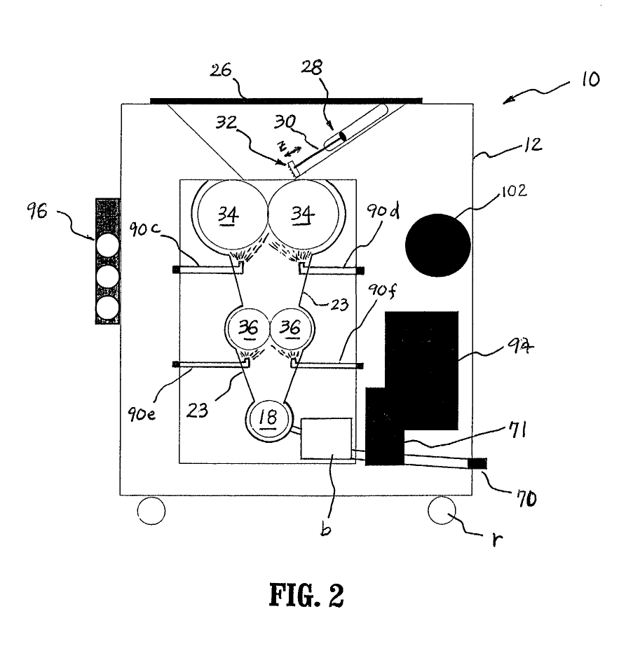

Referring to FIGS. 1-2, the garbage condensing and treating apparatus 10 of the present invention is schematically depicted. Apparatus 10 includes housing 12 and a plurality of mechanisms which are at least partially disposed or supported by the housing 12. The major mechanisms include, in sequence of operation, a garbage input mechanism 14, a comminution mechanism 16, a compaction and dewatering mechanism 18 and a garbage discharge mechanism 20. These mechanisms as well as the auxiliary mechanisms of the apparatus 10 will be discussed in greater detail hereinbelow.

Housing 12 is generally a rectangular frame-like structure having an overall size or dimension approximating that of a commercial washing machine. Housing 12 is portable and preferably mounted on a plurality of rollers or wheels “r” to facilitate location/relocation within the treatment site. Housing 12 may be fabricated from any rigid support material including cast iron, stainless steel or the like, and can be a totally enclosed unit wherein the mechanisms are concealed or, alternatively, an open structure wherein the mechanisms are exposed for ease of access and repair.

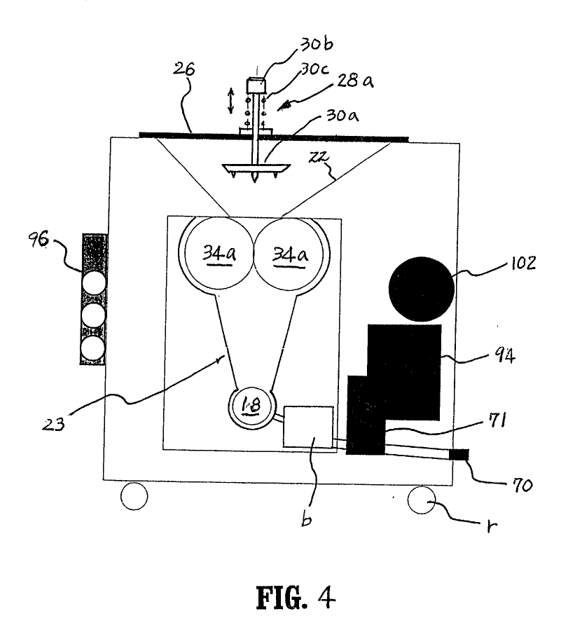

With continued reference to FIGS. 1-2, garbage input mechanism 14 of the apparatus will be discussed. Input mechanism 14 includes hopper 22 for receiving the disposed garbage material “M” and having input opening 24, lid 26 for selectively covering and uncovering the opening 24, and an input facilitator 28 disposed adjacent the hopper 22. The apparatus also may include guide panels 23 for guiding the garbage material within the housing 12. Lid 26 is preferably pivotally mounted to hopper 22 through conventional means and pivots about an axis of rotation to expose the opening 24. Input facilitator 28 includes a reciprocating pusher 30 which advances toward comminution mechanism 16 to engage the garbage material “M” introduced into hopper 22 to direct the material toward comminution mechanism 16. Pusher 30 may possess a sharp edge or knife 32 which serves to cut the garbage material “M” prior to entry within the comminution mechanism 16. Thus, input facilitator 28 serves the dual function of initially cutting the garbage material “M” prior to entry into comminution mechanism 16 and to properly direct the garbage material “M” into the comminution mechanism 16. Input facilitator 28 may be actuated with a compressed air mechanism, solenoid motor, etc. as appreciated by one skilled in the art to provide the oscillating or reciprocating movement to pusher 30 (the reciprocating movement being indicated by the directional arrows Z in FIG. 2). Alternatively, as shown in FIG. 4, input facilitator 28a may be hand operated and movable in the reciprocating directions depicted by the directional arrows. In accordance with this embodiment, pusher 30a includes a handle 30b dimensioned to be grasped by the user. Movement of the pusher 30a in the downward direction engages the garbage material “M” as discussed above. Preferably, pusher 30a is normally biased in the upward direction by coil spring 30c.

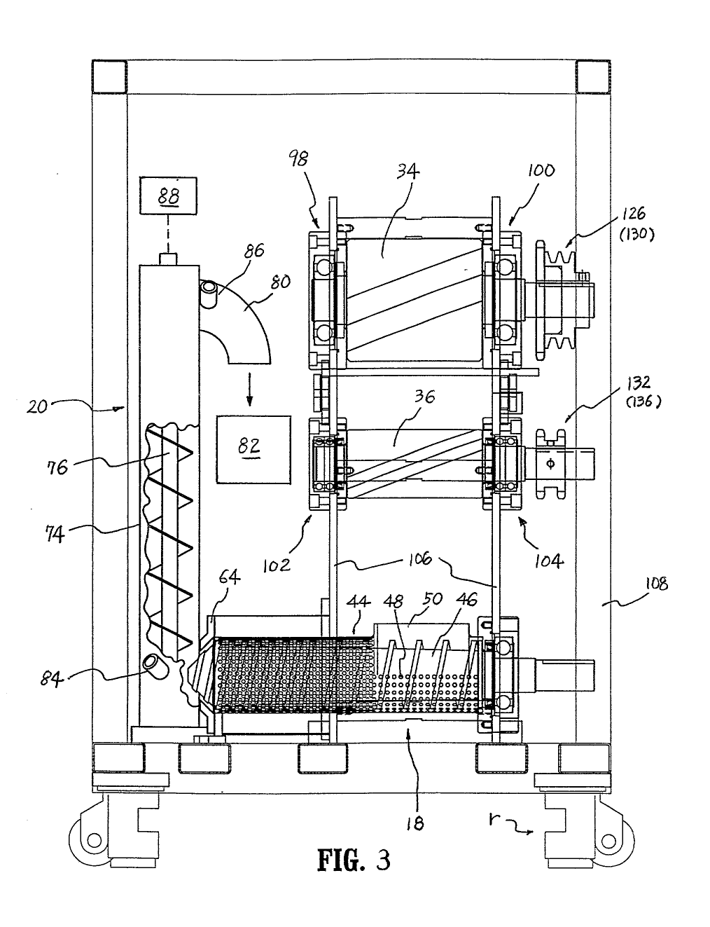

Referring now to FIGS. 1-2, in conjunction with the side plan view of the apparatus of FIG. 3, comminution mechanism 16 will be discussed. Comminution mechanism 16 is disposed beneath input mechanism 14, i.e., downstream with respect to input mechanism 14 along the path of travel of the garbage material “M”. Comminution mechanism 16 pulverizes the garbage material “M” into smaller pieces. In the preferred embodiment, comminution mechanism 16 operates in two-stages, i.e., including a first set of primary gears 34 and a second set of secondary gears 36. Generally stated, primary gears 34 provide a relatively coarse comminuting action on the garbage material “M” to pulverize the garbage material “M” to smaller coarse pieces. Secondary gears 36 provide a relative fine (compared to primary gears 34) comminuting action on the garbage material “M” passed through primary gears 34 to further pulverize the garbage material “M” to more fine or smaller pieces for subsequent handling by the compaction mechanism 18. It is also envisioned that comminution mechanism 16 may be a one stage mechanism as depicted in FIG. 4. In accordance with this embodiment, only one set of gears, e.g., primary or secondary 34a, 36a, is incorporated to pulverize the garbage material. Additional gear arrangements are also contemplated including a tertiary set of gears, etc. It is further envisioned that primary and secondary gears 34, 36 may be identical in size and function to provide the same comminuting effect on the material.

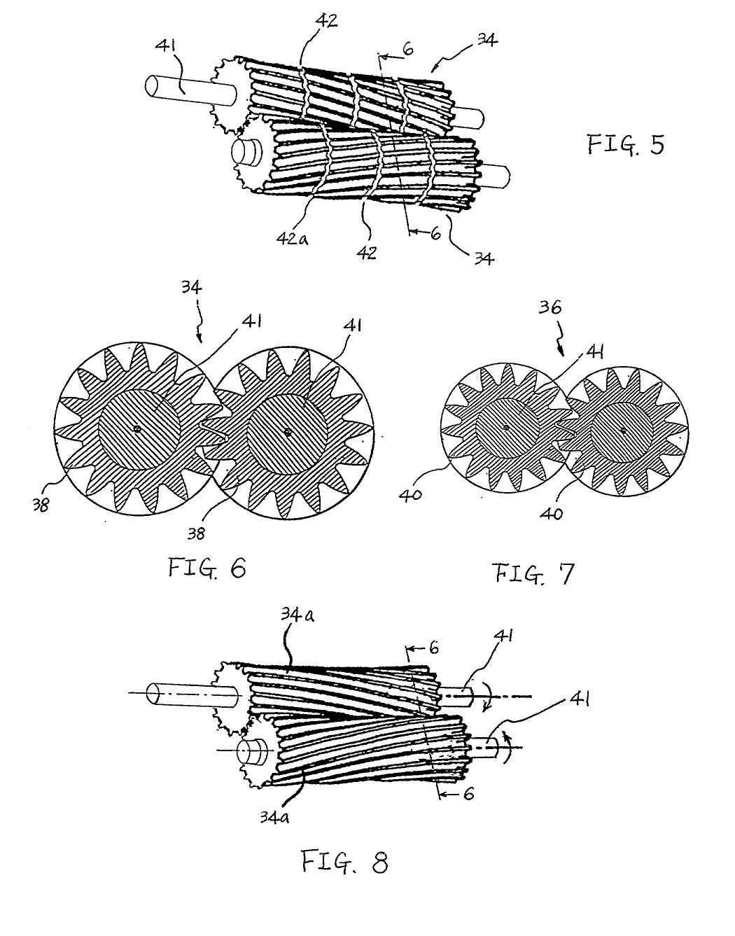

FIGS. 5-6 illustrate the details of primary gears 34 and FIG. 7 illustrates the details of secondary gears 36. Primary gears 34 and secondary gears 36 are substantially similar in structure except for the respective size of these gears and the size of the associated teeth. Primary and secondary gears 34, 36 are preferably helical gears having respective teeth 38, 40 which intermesh and cooperate to crush and/or pulverize the garbage material “M” passing therethrough. Alternatively, primary and secondary gears 34, 36 may be spur gears. Primary gears 34 are mounted on gear axles 41 which in turn are operatively connected to a drive mechanism which inputs rotational movement to the gears 34. Secondary gears 36 are arranged in a similar manner. The teeth 38, 40 of primary and secondary gears 34, 36 are advantageously dimensioned, e.g., having a predetermined width and height, to crush and pulverize the garbage material “M” including both wet garbage and any materials accompanying the wet garbage such as paper dishes, napkins, plastics, bones, wood, steel scraps, etc. without risk of failure of the gears 34, 36. This configuration provides significant advantages over prior art devices having knives, shredders, etc. for slicing the garbage, but, which are incapable of handling such relative “hard” waste material. The teeth 38 of primary gears 34 define a depth or height sufficient to provide the desired relative coarse cutting or breaking action. The teeth 40 of secondary gears 36 define a depth or height less than primary gears to provide the relative fine cutting action on the garbage material “M”.

As best depicted in FIG. 5, in the preferred embodiment, primary gears 34 and/or secondary gears 36 include a plurality of input grooves 42 extending through the teeth of the gears 34, 36 and circumscribing their respective outer surfaces. Input grooves 42 substantially minimize movement of the garbage material “M” in an axial direction along the outer surface of gears 34, 36. More specifically, the garbage material “M”, when subjected to the grinding action of the gears 34, 36, exhibits a tendency to travel along the outer surface of the gears 34, 36 without entering the intergear space. Input grooves 42, however, provide a discontinuous surface whereby the outer edges 42a defining the grooves 42 engage the garbage material “M” to substantially prevent such axial movement along the gear outer surface. Accordingly, the garbage material “M” is directly fed (via gravity and by the action of the gears) through the primary and/or secondary gears 34, 36. The outer edges 42a also assist in cutting or breaking the garbage material “M” upon passage through the gears. Grooves 42 are arranged in spaced relation along the axis of gears 34, 36. Preferably, three grooves 42 are provided although more or less grooves may be incorporated into the gears 34, 36 if desired. Grooves 42 may extend completely through the teeth 38, 40 of the gears 34, 36 or alternatively, may only partially extend through the teeth. Preferably, the input grooves 42 extend in general transverse relation to the axis of the gears. However, other oblique relations are envisioned as well. In an alternate embodiment, depicted in FIG. 8, the input grooves 42 are removed. This embodiment is also effective for its intended purpose, particularly in association with the input facilitator 28 or the like, but fails to provide the advantages associated with the grooves as discussed herein.

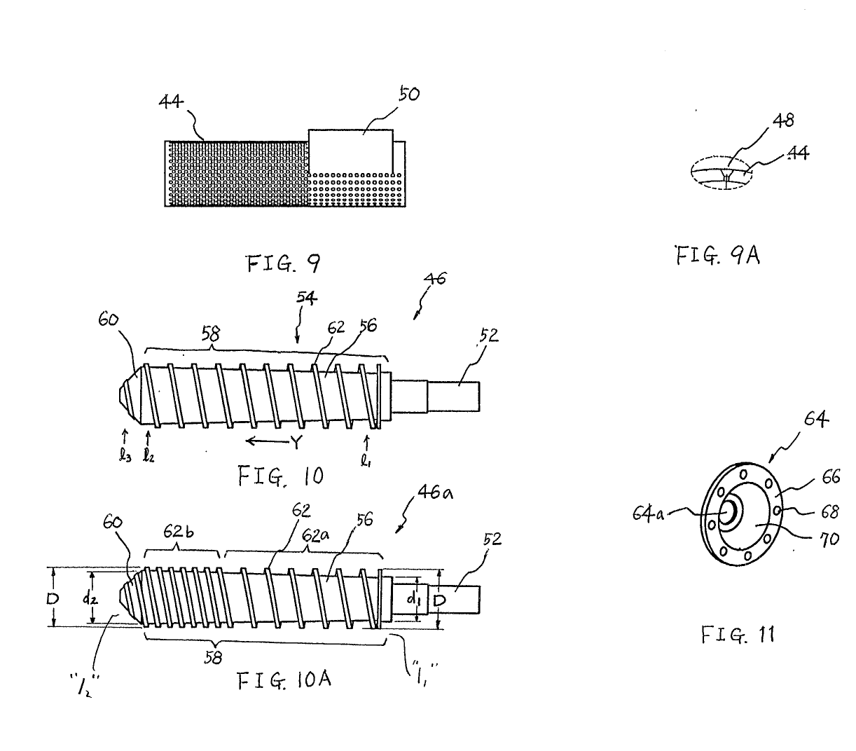

With reference again to FIGS. 1-3, taken in conjunction with FIGS. 9-11, the compaction and dewatering mechanism 18 will be discussed. Compaction and dewatering mechanism 18 is disposed downstream of the comminution mechanism 16, and is adapted to compress the garbage material “M” and substantially remove the liquids, e.g., water, from the material. Compaction and dewatering mechanism 18 includes cylindrical filter 44 and compaction screw 46 coaxially mounted within the filter 44. Cylindrical filter 44 includes a plurality of drainage holes 48 disposed about its periphery to permit the liquid to drain from the filter 44 during compression of the garbage material “M” within the filter 44. As depicted in FIG. 9A which illustrates an enlarged sectional view of one of the plurality of drainage holes 48, the holes 48 are preferably counter-sunk to facilitate drainage of waste liquid and cleaning of the holes with compressed air or water stream as will be discussed. Alternatively, drainage holes 48 may be simple or straight bore configurations. As shown in FIG. 9, cylindrical filter 44 further includes hopper 50 disposed at the leading end of the filter 44. Hopper 50 collects the garbage material “M” exiting the comminution mechanism 16 for passage through into filter 44. Hopper 50 may be a separate component connected to filter 44 or, alternatively, be integrally formed with the filter.

With particular reference to FIG. 10, compaction screw 46 of the compaction and dewatering mechanism 18 includes shaft portion 52 and screw portion 54 extending from the shaft portion 52. Shaft portion 52 is connectable to a drive mechanism which inputs rotational movement to compaction screw 46. Core shaft portion 56 of the screw portion 54 defines a generally double tapered or conical configuration having a core diameter which gradually increases from an upstream location (l₁) to a first downstream location (l₂) to define a main taper or conical section 58, and then gradually decreases from the first downstream location (l₂) to a second downstream location (l₃) to define a second reverse taper or conical section 60. However, the outer diameter (D) of external thread 62 is preferably constant throughout the length of the main conical section 58 to facilitate movement of the garbage material “M” toward the downstream location (l₂). It is also envisioned that the outer portion of the external thread 62 and the inner corresponding surface portion of the filter 44 may be in respective tapered configurations. Main conical section 58 effectively compresses the garbage material “M” while removing most of the liquid as the material “M” advances within cylindrical filter 44. More specifically, as the garbage material “M” moves from the entry (upstream) to exit (downstream) end of filter 44 (in the direction of directional arrow Y), upon rotation of compaction screw 46 the garbage material “M” is gradually compressed against the inner surface of filter 44 thereby resulting in the liquid being “squeezed” from the material and drained through the filter 44. The second conical section permits and directs the garbage material “M” from cylinder filter 44.

In the preferred embodiment, the external thread 62 of screw portion 54 has a constant pitch throughout the major length of the screw portion (FIG. 10). Alternatively, as depicted in FIG. 10A, thread 62 may have a variable pitch, e.g., a two stage pitch, whereby an upstream portion 62a of the screw has a pitch which is greater than (e.g., twice) the downstream portion 62b. This arrangement increases the compaction ratio effect on the garbage material “M”.

Referring now to FIG. 3, in conjunction with FIG. 11, compaction and dewatering mechanism 18 further includes conical cap 64 mounted to housing 12 adjacent the second conical section 60 of compaction screw 46. Conical cap 64 functions to direct the garbage material “M” to discharge mechanism 20. Conical cap 64 includes flange portion 66 with a plurality of mounting holes 68 for mounting to housing 12 as shown in FIG. 3. Cap 64 further includes inner conical taper portion 70 which corresponds to second conical section 60 of compaction screw 46 to cover the second conical section while leaving appropriate circumferential space to permit discharge of the compacted garbage material through discharge opening 64a of the cap 64.

As depicted in FIGS. 1 and 2, compaction and dewatering mechanism 18 may further include a basin “b” to accumulate the drained liquid dropping down from comminution mechanism 16 and passing through filter 44, and duct 70 through which the drained liquid is removed. A pump 71 for draining the liquid through duct 70 may also be provided.

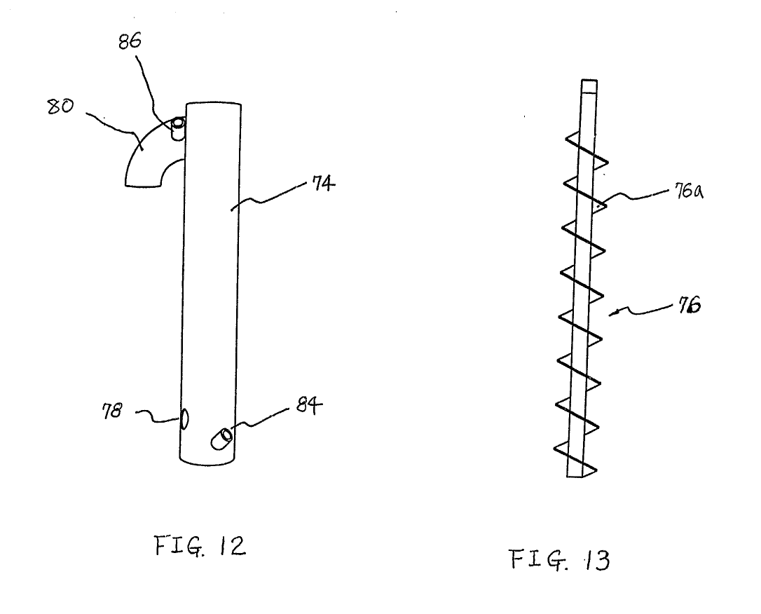

With reference now to FIGS. 1, 3 and 12-13, garbage discharge mechanism 20 of the apparatus 10 will be discussed. Discharge mechanism 20 collects the condensed and deliquified garbage material “M” exiting compaction and dewatering mechanism 18 and directs the material from the apparatus 10 to a discharge bin or receiver. Discharge mechanism 20 includes discharge cylinder 74 and discharge screw 76 which is rotatably mounted within the discharge cylinder 74. Discharge cylinder 74 is a cylindrical tube-like structure and possess garbage intake opening 78 at its lower end which is in alignment with discharge opening 64a of conical cap 64 of compaction and dewatering mechanism 18 to thereby receive the garbage material “M” exiting the dewatering mechanism 18. Discharge cylinder 74 further includes discharge outlet duct 80 having an arcuate configuration which ejects the garbage material “M” into a garbage receiver or receptacle 82 as schematically detailed in FIGS. 1 and 3. Discharge cylinder 74 also includes a chemical port 84 disposed adjacent its lower end to permit delivery of chemical agents to the garbage material “M” prior to exiting the apparatus and an air port 86 adjacent its upper end for receiving compressed air to facilitate ejection of the garbage material “M” as will be discussed.

Discharge screw 76 is preferably an Archimedes screw 76a, helical screw, or the like adapted to lift the garbage material “M” toward outlet duct 80. A motor 88 is operatively connected to discharge screw 76 to impart the necessary rotational movement to screw 76. Discharge screw 76 and cylinder 74 are preferably arranged in a vertical manner although it is appreciated that the screw and cylinder 74 may extend at an oblique angle as well.

Referring again to FIGS. 1-3, the remaining auxiliary mechanisms of the apparatus 10 will be discussed. Apparatus 10 may further include a water spray mechanism 90 including at least on spray duct identified schematically as reference numerals 90a-90f in FIGS. 1 and 2. Spray mechanism 90 is connectable to a water source, e.g., a sink 92, and may be directed to spray pressurized water (as indicated by arrows L) against primary and secondary gears 34, 36 to remove or clean garbage remnants from the gears and/or to provide lubricative effect to the gears, utilizing water as a lubricant. As shown in FIG. 1, two spray ducts 90a and 90b may be provided to direct pressurized water toward primary gears 34 and secondary gears 36, respectively. Alternatively, as shown in FIG. 2, four spray ducts 90c-90f may be provided to spray pressurized water toward each of the gears 34 and 36. Spray mechanism 90 may also be utilized to remove garbage remnants from the other mechanisms of the apparatus 10. Alternatively, spray mechanism 90 could be replaced or used in conjunction with a compressed air mechanism to remove remnant particles. A suitable compressed air source or compressor 94 may be housed within housing 12 or may be an independent mechanism connected through conventional means to the apparatus. The air source 94 may include a nozzle to direct the pressurized air over the desired compartment as appreciated by one skilled in the art. It is also envisioned that compressed air may be directed to such compartments through the water spray ducts 90a-90f. A suitable control valve (not shown), in conjunction with an adequate control mechanism of the apparatus, may be provided to switch and operatively control the flow of such pressurized water and compressed air.

In addition, the apparatus further includes control panel 96 for operation and control of the apparatus by the operator. For the operation of the apparatus, including operation of the driving system to be discussed hereinafter, a programmable logic controller (PLC) may be provided in association with the control panel 96. As shown in FIG. 3, the apparatus may also include adequate bearings and covers 98-104 for mounting of the gears 34, 36 to panel 106 of housing frame 108.

With reference again to FIG. 1, apparatus 10 may also include chemical application mechanism 110 for delivering chemical agents to the garbage material “M” prior to exiting the apparatus. Chemical application mechanism 110 is disposed adjacent garbage discharge mechanism 20. Chemical application mechanism 110 includes at least one chemical storage container 112 (three are shown) and exhaustion duct 114 which is attached to chemical port 84 of garbage discharge cylinder 74. Chemical substances stored within containers 112 may include deodorants, aroma producing materials, appetite reducers to animals, and/or other materials or medicinal, for various purposes. In one preferred application, compressed air source 94 is in fluid communication with storage containers 112 and with air port 86 of discharge cylinder 74 of the discharge mechanism 20 and mixes with chemical substances stored in powder or liquid form in the storage containers 112 to direct the agents through branch tubes shown by dashed lead arrows “M” and into chemical exhaustion duct 114. The chemicals then travel under the vacuum pressure generated by the introduction of compressed air through air port 84 of discharge cylinder 74 to mix with the garbage material “M” moving upwards within the cylinder 74.

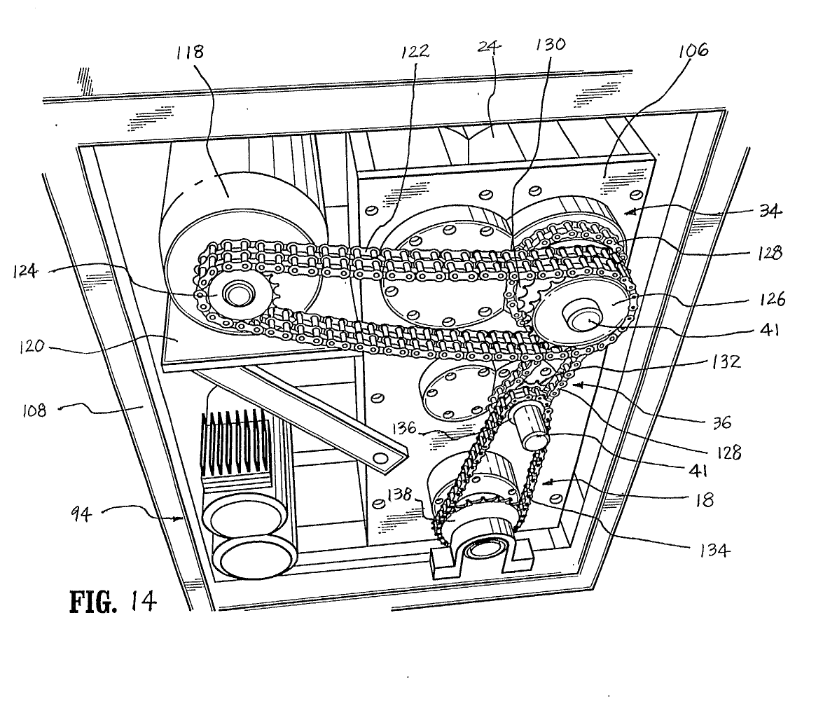

Referring now to FIG. 14, a rear view of the apparatus 10 is shown to depict various components of the driving system. The primary and secondary gears 34, 36, and the compaction and dewatering assembly 18 are shown within frame 106. Motor 118 mounted on bed 120 operates primary and secondary gears 34, 36. In a preferred application, first chain 122 is mounted to corresponding chain sprockets 124 and 126 respectively which are attached to motor 118 and primary gears 34. Second chain 128 is mounted to corresponding chain sprockets 130 and 132 respectively which are attached to primary gears 34 and secondary gears 36. Also, a third chain 134 is mounted to corresponding chain sprockets 136 and 138 respectively which are attached to secondary gears 36 and the compaction and dewatering assembly 18. By selecting appropriate sprocket pitches of the apparatus, the rotation speed of the gears 34 and 36 and compaction screw 46 may be controlled to desired rates for each of the components. Particular design of the chain drive system including chains and sprockets is well known in the art.

Operation of the Apparatus

The use of apparatus will now be discussed. In the following description, treatment of the garbage material “M” is discussed in terms of a path of travel through apparatus 10 from the entry (upstream) end of the apparatus to the exit (downstream) end. Initially, the user opens lid 26 of hopper 22 and dispenses the garbage material “M” into the hopper 22. Thereafter, upon pushing a “Start” button of the control panel 96, the apparatus starts its operation preferably under the control of the programmable logic controller as discussed above. Water spray mechanism 90 may be first activated to spray pressurized water against the gears 34 and 36 to remove garbage remnants and lubricate the gears 34 and 36 during the operation. It is to be noted that water spray mechanism 90 may be occasionally activated during the operation of the apparatus by the automatic control of the programmable logical controller or menu selection by the operator. Input facilitator 28 is then activated to direct the garbage material toward comminution mechanism 16. Simultaneously therewith, knife 32 of pusher 30 cuts the garbage material “M” prior to entry in the comminution mechanism 16.

The garbage material “M” enters primary gears 34 (Arrow A) which pulverizes, crushes, etc., the garbage material to form smaller garbage pieces. As noted above, input grooves 42 of primary gears 34 facilitate passage of the garbage material “M” through the gears while also assisting in cutting the garbage material “M”. The garbage particles then pass (Arrow B) through secondary gears 36 and are pulverized into more fine particle sizes. Input grooves 42 of secondary gears 36 will assist in passage of the material in a similar manner. The fine garbage particles “M” enters hopper 50 of compaction filter (Arrow C) where it is conveyed and compressed within the compaction and dewatering mechanism 18 (Arrow D). Upon compression, the liquid, e.g., water, is removed from the garbage material “M” and drains through filter 44 and out discharge duct 70 via the pumping action of pump 71, as indicated by dashed arrows P and Q. The drained liquid is discharged into a sink 92.

The condensed garbage material “M” enters discharge mechanism 20. The garbage material “M” is conveyed upwardly by ascension screw 76 (Arrow E). As noted above, chemical application mechanism 94 may be activated to discharge chemical agents into the material “M” during movement of the material within discharge cylinder 74. The garbage material “M” is then directed through discharge outlet duct 80 (Arrow F) and into storage receptacle 82 of the apparatus (Arrow G). When the storage receptacle 82 is filled, the garbage material is removed by the user.

Thus, by virtue of the apparatus of the present invention, the volume and water content of the disposed garbage material is substantially reduced, sometimes as much as 75%, thus providing significant economic and environmental benefits.

While the above description contains many specifics, these specifics should not be construed as limitations on the scope of the disclosure, but merely as exemplifications of preferred embodiments thereof. For example, it is envisioned that the garbage condensed by the compaction and dewatering assembly 18 may be discharged directly to an outside garbage receptacle without conveying upwards through the ascending cylinder or the like. Those skilled in the art will envision many other possible variations that are within the scope and spirit of the disclosure as defined by the claims appended hereto.

What is claimed is:

1. An apparatus for treating and condensing wet garbage, which comprises:
a housing having a garbage inlet and a garbage outlet associated therewith and defining a treatment path along which wet garbage passes for treatment;
a pair of primary comminuting gears disposed along said treatment path downstream of said garbage inlet for providing a primary comminuting action on the wet garbage; and
a pair of secondary comminuting gears disposed along said treatment path downstream of said primary comminuting gear for providing a secondary comminuting action on the wet garbage.

2. The apparatus according to claim 1 wherein said primary comminuting gears are configured to cooperate to provide a relative coarse comminuting action on the wet garbage.

3. The apparatus according to claim 2 wherein said secondary comminuting gears are configured to cooperate to provide a relative fine comminuting action on the wet garbage.

4. The apparatus according to claim 2 wherein said primary comminuting gears having intermeshing teeth.

5. The apparatus according to claim 4 wherein at least one of said primary comminuting gears includes a groove extending at least partially through said teeth, said groove dimensioned to facilitate passage of the garbage material between said primary gears.

6. The apparatus according to claim 5 wherein said groove extends in general transverse relation to an axis of rotation of said at least one primary comminuting gear.

7. The apparatus according to claim 6 wherein each said primary comminuting gear includes a groove.

8. The apparatus according to claim 7 wherein said primary comminuting gears are helical gears.

9. The apparatus according to claim 3 wherein said secondary comminuting gears having intermeshing teeth.

10. The apparatus according to claim 9 wherein at least one of said secondary comminuting gears includes a groove extending at least partially through said teeth, said groove dimensioned to facilitate passage of the garbage material between said secondary helical gears.

11. The apparatus according to claim 10 wherein said groove extends in general transverse relation to an axis of rotation of said at least one secondary comminuting gear.

12. The apparatus according to claim 11 wherein each said secondary comminuting gear includes a groove.

13. The apparatus according to claim 8 wherein said secondary comminuting gears are helical gears.

14. The apparatus according to claim 1 including a compacting member disposed downstream of said secondary comminuting gear, said compacting member dimensioned and configured to at least provide a compacting action on the wet garbage.

15. The apparatus according to claim 14 wherein said compacting member is a rotatable compacting screw.

16. The apparatus according to claim 15 including a filter having a plurality of liquid drainage openings, said filter at least partially accommodating said compacting screw and cooperating with said compacting screw to reduce the volume and remove liquids of the garbage material upon rotation of said compacting screw.

17. The apparatus according to claim 16 wherein said compacting screw tapers outwardly from an upstream location to a downstream location thereof.

18. The apparatus according to claim 16 including a discharge member disposed downstream of said compacting member, said discharge member configured to convey the garbage material toward said garbage outlet.

19. The apparatus according to claim 18 wherein said discharge member includes a rotatable auger.

20. The apparatus according to claim 1 including an input facilitating member mounted with respect to said housing adjacent said garbage inlet, said input facilitating member configured to direct the wet garbage toward said primary comminuting gears.

21. The apparatus according to claim 1 wherein said input facilitating member includes a pusher, said pusher having a blade associated therewith and adapted for reciprocal movement to sever the wet garbage.

22. The apparatus according to claim 1 including a liquid delivery mechanism for directing a liquid stream adjacent at least one of said primary and secondary gears to remove residual garbage material therefrom.

23. The apparatus according to claim 1 including a treatment applicator for applying a chemical substance to the garbage material prior to passing through said garbage outlet.

24. The apparatus according to claim 23 including a chemical substance source in fluid communication with said treatment applicator, said chemical substance source being selected from the group consisting of deodorants, aroma generating chemicals, preservatives, rodenticides, appetite suppressors, and biocides and the like.

25. An apparatus for condensing substantially wet, raw and/or food garbage material, which comprises:
a housing having a garbage inlet and a garbage outlet associated therewith and defining a treatment path along which the garbage material passes for treatment;
at least one pair of intermeshing comminuting gears disposed along said treatment path downstream of said garbage inlet for providing grinding of the garbage material;
an input facilitator mounted with respect to said housing adjacent said comminuting gears, said input facilitator configured to direct the garbage material toward said comminuting gears;
a compacting screw and filter downstream of said comminuting gears for compacting and removing liquid from the garbage material; and
a discharge member disposed downstream of said compacting screw and filter, said discharge member configured to convey the garbage material toward said garbage outlet.

26. The apparatus according to claim 25 wherein said at least one pair of comminuting gears includes a plurality of grooves extending within the teeth thereof and being dimensioned to facilitate passage of the garbage material through said comminuting gears.

27. The apparatus according to claim 26 including a treatment applicator and chemical source in fluid communication with said treatment applicator, said chemical source including a chemical selected from the group consisting of deodorants, aroma generating chemicals, preservatives, rodenticides, appetite suppressors, and biocides and the like, said treatment applicator arrange to introduce said chemical into the garbage material prior to exiting said garbage outlet.

28. The apparatus according to claim 26 including a liquid delivery mechanism for directing a liquid stream adjacent at least the comminuting gears for cleaning of the apparatus.

29. The apparatus according to claim 26 including a compressed air delivery mechanism for providing compressed air to facilitate operation of the apparatus.
